(19) United States
(12) Patent Application Publication
(10) Pub. No.: US 2023/0371751 A1
(43) Pub. Date: Nov. 23, 2023

(54) BREWING MACHINE FOR PRODUCING MILK

(71) Applicant: GROW UP LLC, Irvine, CA (US)

(72) Inventor: Luiz Felipe Veras Rapacci, Santa Ana, CA (US)

(21) Appl. No.: 18/319,407

(22) Filed: May 17, 2023

Related U.S. Application Data
(60) Provisional application No. 63/343,404, filed on May 18, 2022.
(60) Provisional application No. 63/433,369, filed on Dec. 16, 2022.

(51) Int. Cl. A47J 43/046; A47J 19/00; A47J 43/07; B65D 53/02; B65D 51/24

(52) U.S. Cl. CPC A47J 43/046; A47J 19/00; A47J 43/0722; A47J 43/0727; B65D 53/02; B65D 51/24; A47J 2203/00

(57) ABSTRACT

In accordance with various embodiments, a brewing machine or apparatus is disclosed. The brewing machine is a cold brewing automated plant-based milk maker that brews more than 10 kinds of plant-based milk. The cold brewing process uses filtration and vacuum to maximize milk extraction and minimize vitamin and mineral losses. The brewing machine includes a mesh filter disposed inside the container and configured to receive a food article, a blade assembly disposed inside the mesh filter and configured to fragment the food article to produce a liquid, and a vacuum assembly fluidically coupled to the container and configured to remove the liquid from the container. During brewing operation, the mesh filter is configured to capture the fragmented food article, and the vacuum assembly is configured to suction the liquid produced from the fragmentation of the food article.

### CROSS-REFERENCE TO RELATED APPLICATION

This application claims priority and the benefit of U.S. Provisional Patent Application No. 63/343,404, filed on May 18, 2022, and U.S. Provisional Patent Application No. 63/433,369, filed on Dec. 16, 2022, the contents of which are hereby incorporated by reference in their entirety.

### BACKGROUND

Milk is generally good for you. There are many reasons why milk is part of our everyday diet and nutrients in milk build strong bones and teeth. A major source of milk traditionally consumed by general public comes from animals, such as cows. However, there are also many reasons why consumers desire alternatives to animal milk. Some of the reasons range from lactose intolerance to unpleasant taste and/or smell of dairy milk to simple live style choices to avoid animal products to concerns with growth hormones associated with animals. As alternative to animal milk, plant-based milk options are often appealing to a subset of the population who desires, among many others, vegan diet or suitable lifestyle.

Plant-based milks are typically sourced from nuts (e.g., hazelnuts, hemp seeds), seeds and grains (e.g., sesame, walnuts, coconuts, cashews, almonds, rice, flax, oats), or legumes (e.g., soy). Most of these milks are traditionally made by first soaking the nuts, seeds, or legumes in water, grinding them up into a puree, and then straining the fiber from the liquid. However, the process to produce milk from plant-based ingredients often requires a few different tools, inevitably introducing complexity that creates a barrier to efficiently acquiring plant-based milk. As such, consumers are looking for convenient ways to make their own plant-based milks at home. Therefore, there is a need for technology that can enable consumers to conveniently and efficiently brew their own plant-based milk.

### SUMMARY

In accordance with various embodiments, a brewing machine or apparatus includes a container, a mesh filter disposed inside the container and configured and arranged to receive a food article, a blade assembly disposed inside the mesh filter and configured and arranged to fragment the food article to produce a liquid, and a vacuum assembly fluidically coupled to the container and configured and arranged to remove the liquid from the container, wherein, during operation, the mesh filter is configured and arranged to capture the fragmented food article, and the vacuum assembly is configured and arranged to suction the liquid produced from the fragmentation of the food article.

In accordance with various embodiments, a method of producing milk includes providing an apparatus for producing milk, selecting a recipe from the apparatus, the recipe including a type of food article, an amount of the food article, an amount of water, a duration of brewing time, optionally, wherein the food article is a plant-based food article, measuring the amount of the food article and the amount of water based on the recipe, placing the measured amounts of the food article and water in a container having a mesh filter disposed therein, blending the plant-base food article and water for a first portion of the duration of brewing time, thereby producing the milk and a pulp of the blended-base food article, and vacuum suctioning for a second portion of the duration of brewing time to extract the milk from the pulp.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIGS. 1A, 1B, and 1C illustrate an example of a brewing machine, in accordance with various embodiments.

FIGS. 1D and 1E illustrates cross-sectional views of the brewing machine, in accordance with various embodiments.

FIGS. 1F and 1G illustrate a perspective view and an exploded view, respectively, of a top portion of the container of the brewing machine, in accordance with various embodiments.

FIGS. 1H and 1I illustrate a cross-sectional view and a top view, respectively, of a mesh filter of the brewing machine, in accordance with various embodiments.

FIG. 1J illustrates an assembled view of the brewing machine, in accordance with various embodiments.

FIG. 1K illustrates an exploded view of the brewing machine, in accordance with various embodiments.

FIG. 1L illustrates an exploded view of the filter/blade assembly of the brewing machine, in accordance with various embodiments.

FIGS. 2A-2E illustrate various views of a removable lid assembly, in accordance with various embodiments.

FIG. 3 illustrates a method of producing milk, in accordance with various embodiments.

### DETAILED DESCRIPTION

The apparatus and methods described herein relate to a brewing machine for producing milk (e.g., plant-based milks), in accordance with various embodiments. While the following will discuss producing plant-based milk, it should be understood that the apparatus and methods herein can be used for producing any type of milk product.

The apparatus disclosed herein is capable of automating the milking process of plant-based ingredients into milk for numerous types or kinds of plant-based food (e.g., 10 or more types and kinds). In various embodiments, the brewing machine (also referred to herein as “apparatus”) includes a container, a mesh filter disposed inside the container and configured and arranged to receive a food article, a blade assembly disposed inside the mesh filter and configured and arranged to fragment the food article to produce a liquid, and a vacuum assembly fluidically coupled to the container and configured and arranged to remove the liquid from the container. During operation of the brewing machine, the mesh filter is configured and arranged to capture the fragmented food article, and the vacuum assembly is configured and arranged to suction the liquid produced from the fragmentation of the food article.

In various embodiments, the container can include a removable lid assembly having a plurality of lid components that are configured and arranged to interlock to provide a liquid seal to the container. In various embodiments, the plurality of lid components can include a measuring cup having a handle, the handle configured and arranged to be maneuverable to seal the removable lid assembly against at least a portion of the container and, optionally, includes a triggering mechanism to turn on an operation of the apparatus. In various embodiments, the triggering mechanism comprises a sensor-based switch.

In various embodiments, the plurality of lid components can include a gasket interdisposed between at least two adjacent lid components, the gasket configured to interlock with the two adjacent lid components to provide a liquid seal to at least a portion of the container. In various embodiments, the gasket is configured to provide a liquid seal between the mesh filter and at least the portion of the container. In various embodiments, the gasket is configured to provide a liquid seal between the mesh filter, at least the portion of the container, and the removable lid assembly.

In various embodiments, the mesh filter can include mesh openings in a suitable range to capture the pulp during extraction of the milk. In various embodiments, the range of mesh openings can be between 0.01 mm and 1 mm. In various embodiments, the blade assembly is an integrated blade assembly comprising a plurality of single blades stackable in layers to form an integrated blade having multiple blade components. In various embodiments, each of the plurality of single blades comprises a mounting hole through which each single blade is mounted on a blade shaft to form the integrated blade assembly. In various embodiments, the brewing machine can include a sprout fluidically coupled to the vacuum assembly for removing the liquid from the container. In various embodiments, the mesh filter and/or the blade assembly are removable.

In various embodiments, the brewing machine includes a graphic user interface (GUI) configured to receive a user input for selecting a recipe. In various embodiments, the recipe can include at least one of a selection of the food article, an amount of the food article, and a length of time for fragmenting the food article using the blade assembly. In various embodiments, the GUI can be configured to display a plurality of recipes that are preprogrammed on the GUI and/or one or more recipes that are downloadable from an external source. In various embodiments, the external source can be selected from the group consisting of a network, a computing device, a cloud server, and/or combinations thereof.

In various embodiments, a process of brewing plant-based milk can be performed using the method disclosed herein. In various embodiments, the method includes providing an apparatus for producing milk, selecting a recipe from the apparatus, the recipe including a type of food article, an amount of the food article, an amount of water, a duration of brewing time, optionally, wherein the food article is a plant-based food article, measuring the amount of the food article and the amount of water based on the recipe, placing the measured amounts of the food article and water in a container having a mesh filter disposed therein, blending the plant-base food article and water for a first portion of the duration of brewing time, thereby producing the milk and a pulp of the blended-base food article, and vacuum suctioning for a second portion of the duration of brewing time to extract the milk from the pulp. In various embodiments, the selecting of the recipe is performed on a graphic user interface (GUI) of the apparatus.

In various embodiments, the method may optionally include sealing the container using a removable lid assembly having a plurality of lid components that are configured and arranged to interlock to provide a liquid seal to at least a portion of the container. In various embodiments, the plurality of lid components may include a measuring cup having a handle, wherein the handle is configured and arranged to be maneuverable to seal the removable lid assembly against at least the portion of the container. In various embodiments, sealing the container using the removable lid assembly can include providing a gasket using a gasket to form the liquid seal between the mesh filter and at least the portion of the container. In various embodiments, the gasket forms the liquid seal between the mesh filter, at least the portion of the container, and the removable lid assembly. In various embodiments, the mesh filter used in the process of brewing plant-based milk may have mesh openings in a range between 0.01 mm and 1 mm.

In various embodiments of the process of brewing plant-based milk, the method may optionally include draining the milk from the pulp prior to perform vacuum suctioning. In various embodiments, draining the milk from the pulp can be performed for a third portion of the duration of brewing time. In various embodiments, the pulp of the blended plant-base food article is filtered inside the mesh filter during draining and vacuum suctioning. In various embodiments, the extracted milk is collected via a sprout that is fluidically coupled to a vacuum assembly of the apparatus used for vacuum suctioning. In various embodiments, the process of brewing plant-based milk can be performed at room or near room temperature or within a temperature range between 33° F. and 90° F., between 40° F. and 80° F., or between 50° F. and 72° F.

As disclosed herein, the disclosed brewing process can use a combination of filtration and vacuum to maximize milk extraction and minimize vitamin and mineral losses. Moreover, the consumer can choose from more than then kinds of plant bases and consume the milk right away. As stated above, consumers are looking for convenient ways to make their own plant-based milk at home. The included GUI of the brewing machine can enable the consumer to use the interactive screen and add the indicated amount of the plant base and water, using the built-in measuring cup. The disclosed brewing machine and methods of using the machine offers capabilities that do not currently exist. For example, currently available milk makers are typically configured to use heat to break down the plant base fibers, whereas the disclosed brewing machine described herein does not include application of heat in blending of the plant-based food article. As such, some significant benefits of the disclosed brewing machine may include, for example, making plant-based milk without heating the raw food article so as to minimize the loss of nutrients, such as vitamins and minerals, which are essential nutritional benefits of plant-based milk. Moreover, with the built-in filtering system of the disclosed brewing machine, a wider range of plant base food article can be used with the disclosed machine. In addition, since the disclosed brewing process is performed at room temperature, and uses filtration and vacuum to maximize milk extraction and minimize vitamin and mineral losses, all these benefits culminate in an improved plant-based brewing machine. Further details of the disclosed brewing machine and the method of brewing milk using the machine are described with respect to the following figures.

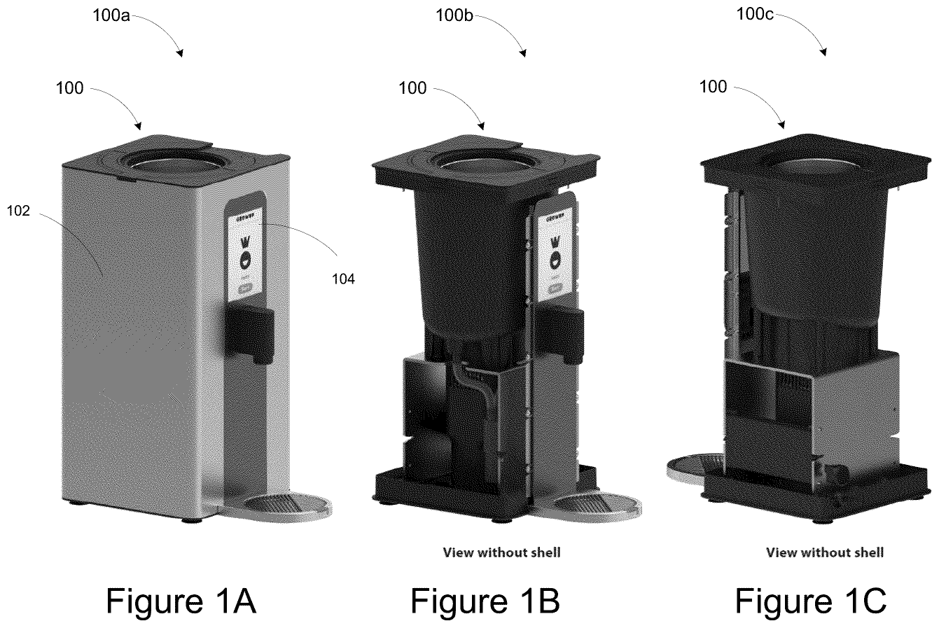

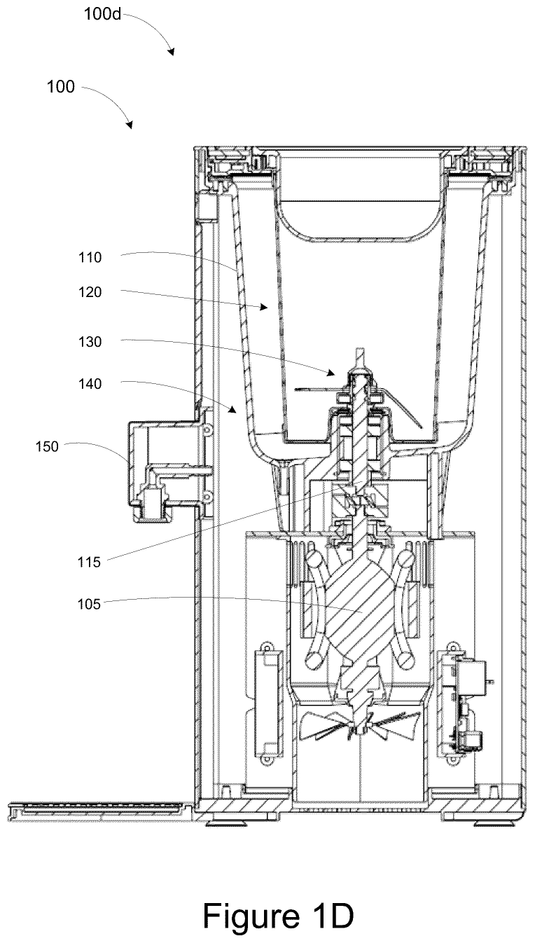

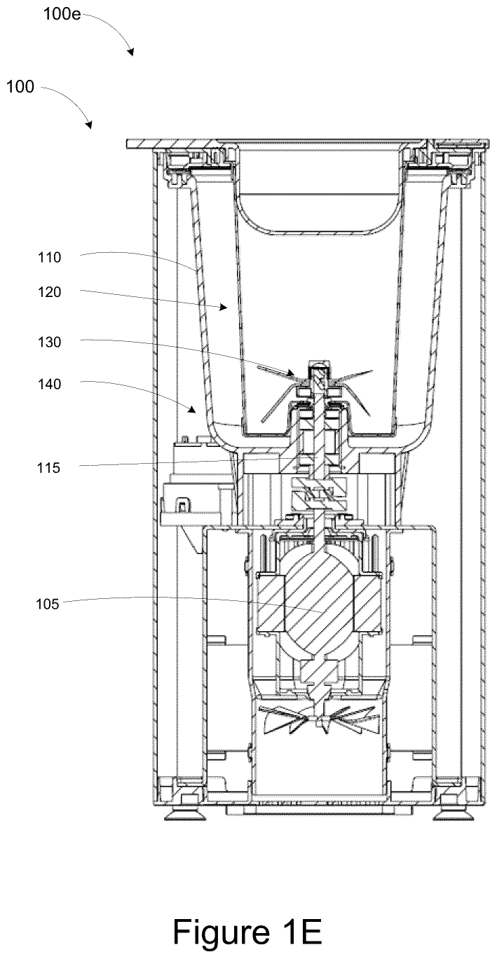

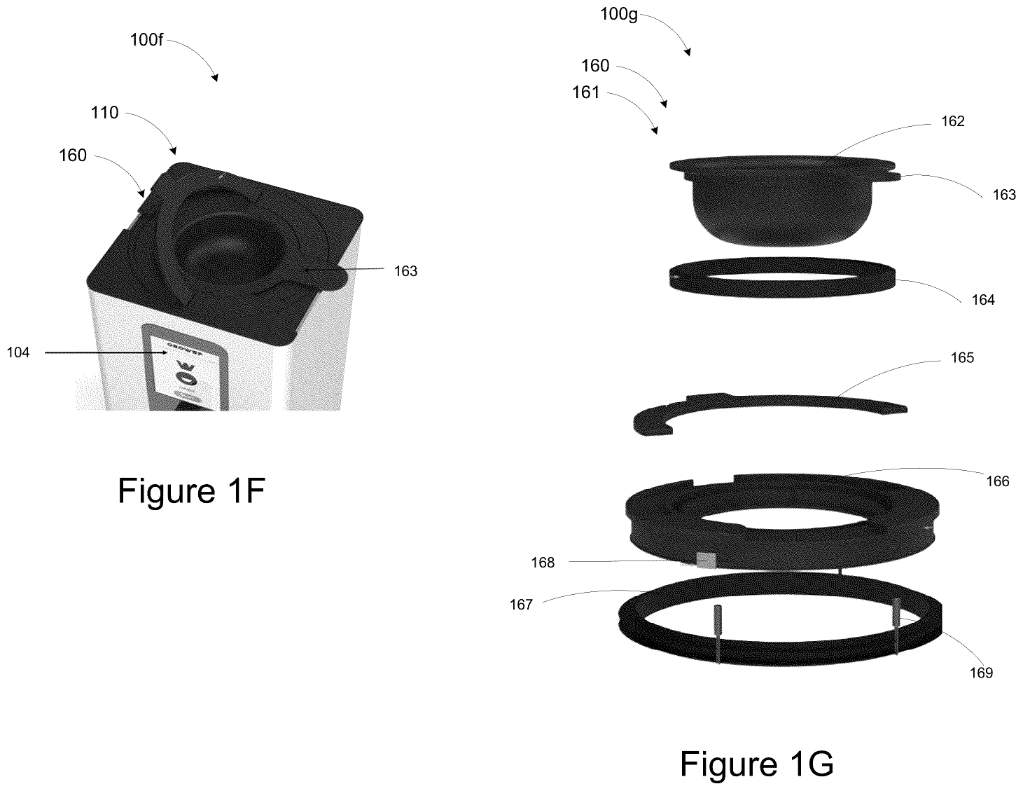

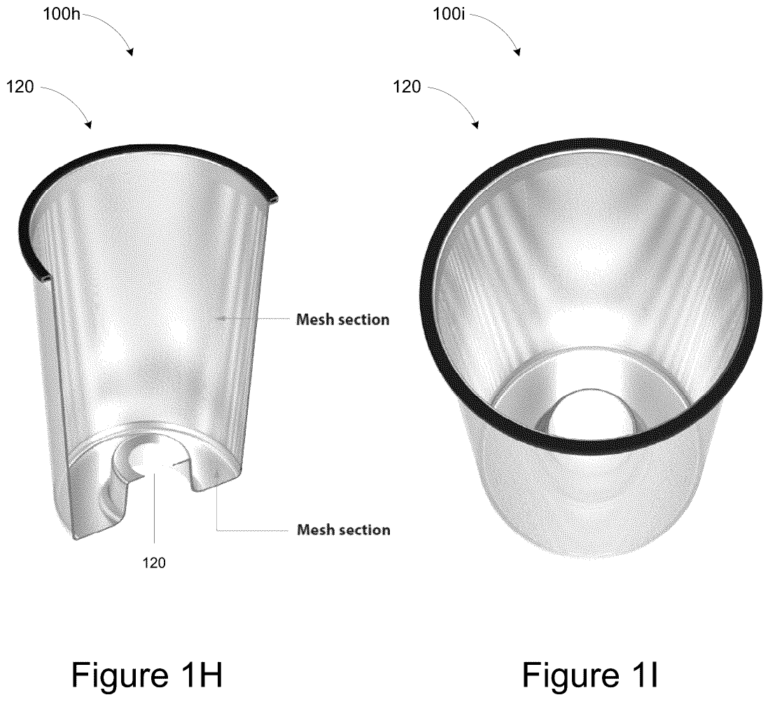

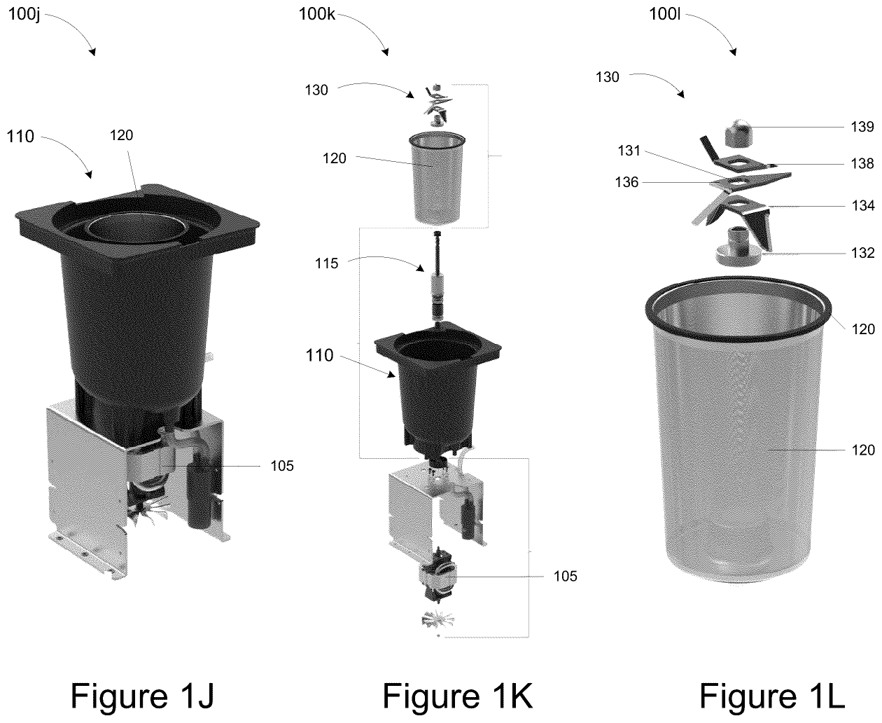

FIGS. 1A, 1B, and 1C illustrate an example of a brewing machine 100, in accordance with various embodiments. Specifically, FIG. 1A shows a view 100a of the brewing machine 100 with a housing or a shell 102 and a user interface 104, FIG. 1B shows a view 100b of the brewing machine 100 without the housing/shell 102, and FIG. 1C shows a view 100c of the brewing machine 100 from another perspective without the housing/shell 102.

FIGS. 1D and 1E illustrates cross-sectional views 100d and 100e, respectively, of the brewing machine 100, in accordance with various embodiments. As illustrated in cross-sectional views 100d and 100e, the brewing machine 100 includes a container 110, a mesh filter 120 disposed inside the container and configured and arranged to receive a food article (not shown), a blade assembly 130 disposed inside the mesh filter 120 and configured and arranged to fragment the food article to produce a liquid (not shown), and a vacuum assembly 140 fluidically coupled to the container 110 and configured and arranged to remove the liquid from the container. As illustrated in FIGS. 1D and 1E, the blade assembly 130 is mounted on a blade shaft 115 driven by a motor 105. Further, the brewing machine 100 includes a sprout 150 fluidically coupled to the vacuum assembly 140 for removing the liquid from the container 100, in accordance with various embodiments. In various embodiments, the vacuum assembly 140 is fluidically coupled to the sprout 150 via a pump (not shown) for extraction of the liquid from the container 110 to the sprout 150.

In various embodiments, for operating of the brewing machine 100, the user interface 104 may include a touch screen or the graphic user interface (GUI) that is configured to receive a user input for selecting a recipe, wherein the recipe includes at least one of a selection of the food article, an amount of the food article, and a length of time for fragmenting the food article using the blade assembly 130.

FIGS. 1F and 1G illustrate a perspective view 100e and an exploded view 100f of a top portion of the container 110 of the brewing machine 100, in accordance with various embodiments. As illustrated in views 100e and 100f, the container 110 of the brewing machine 100 includes a removable lid assembly 160 having a plurality of lid components 161 that are configured and arranged to interlock to provide a liquid seal to the container. In various embodiments, the plurality of lid components 161 includes a measuring cup 162 having a handle 163, the handle configured and arranged to be maneuverable to seal the removable lid assembly 160 against at least a portion of the container 110. In various embodiments, the handle 163 is configured to be pushed or rotated, clockwise or counterclockwise, left or right, to either lock or unlock when the measuring cup 162 is placed within the removable lid assembly 160 on the brewing machine 100.

In various embodiments, the plurality of lid components 161 includes one or more gaskets 164 or 167 interdisposed between at least two adjacent lid components (e.g., measuring cup 162 and lid components 165 or 166), wherein the gasket 164 (or gasket 167) is configured to interlock with the two adjacent lid components 162 and 165/166 to provide a liquid seal to at least a portion of the container 110. In various embodiments, the gasket 167 (or gasket 164) is configured to provide a liquid seal between the mesh filter 120 and at least the portion of the container 110. In various embodiments, the gasket 164 and/or gasket 167 is/are configured to provide a liquid seal between the mesh filter 120, at least the portion of the container 110, and the removable lid assembly 160.

In various embodiments, the plurality of lid components 161 optionally includes a triggering mechanism 168/169 to turn on an operation of the brewing machine 100. In various embodiments, the triggering mechanism 168/169 is a sensor-based switch that includes a sensor 169 and a sensor trigger 168 (which can be a rod, a protrusion, a magnet, a capacitive pad, etc.). In various embodiments, the triggering mechanism 168/169 is an electronic, a magnetic, and/or mechanical locking mechanism. In various embodiments, the locking mechanism can include a microswitch mechanism. In various embodiments, the removable lid assembly 160 or the plurality of lid components 161 can include a release valve (not shown) which can be used to release pressure from suction during milk extraction within the container 110 when a brewing operation is completed. In various embodiments, the release valve can be triggered by an application of the triggering mechanism 167 or a separate switch that enables operation of the release valve.

FIGS. 1H and 1I illustrate a cross-sectional view 100h and a top view 100i, respectively, of the mesh filter 120 of the brewing machine 100, in accordance with various embodiments. As illustrated in views 100h and 100i, the mesh filter 120 includes a protruding portion 122 extending from a bottom of the mesh filter 120. In various embodiments, the protruding portion 122 is configured such that the blade assembly 130 can be installed properly and raised above the bottom of the mesh filter 120. In various embodiments, the raised position of the protruding portion 122 allows for the milk from the fragmented or disintegrated food article be extracted via the mesh pores of the mesh filter 122 while the pulp is captured within the mesh filter 120. In various embodiments, the raised position of the protruding portion 122 is configured such that a hole at the center of the protruding portion 122 does not permit removal of milk via the hole.

FIG. 1J illustrates an assembled view 100j of the brewing machine 100, in accordance with various embodiments. As illustrated in the view 100j, the brewing machine 100 is shown with the container 110 that has the mesh filter 120 disposed therewithin. The container 110 portion is fluidically coupled to a fluid outlet or a sprout (e.g., sprout 150) via the pump (not shown).

FIG. 1K illustrates an exploded view 100k of the brewing machine 100, in accordance with various embodiments. As illustrated in the view 100k, the brewing machine 100 includes the container 110 which, as illustrated in FIG. 1K, is configured to disposed therewithin the mesh filter 120, which is configured to disposed therewithin the blade assembly 130, which is driven by the motor 105 via the blade shaft 115. As illustrated in FIG. 1K, the blade assembly 130 is configured to be mounted on the blade shaft 115 for cutting or fragmenting the food article.

FIG. 1L illustrates an exploded view 100l of the filter 120/blade assembly 130 of the brewing machine 100, in accordance with various embodiments. As shown in FIG. 1L, the mesh filter 120 can be configured to hold a filter gasket 124 to provide a liquid seal against the removable lid assembly 160 and/or the container 110. As illustrated in the view 100l, the blade assembly 130 includes a blade shaft 132, a bottom blade 134, a middle blade 136, a top blade 138, and a blade nut 139. All blade components 132, 134, 136, 138, and 139 of the blade assembly 130 have a mounting hole 131 that is used for mounting the components on the blade shaft 115 to be driven by the motor 105.

In various embodiments, the motor 105 can be an AC motor that is run at 120V at 60 Hz, and/or at 400 W.

In various embodiments, the user interface 104 can be a digital display touch screen that accepts a user input for operating the brewing machine 100.

In various embodiments, the container 110 can have a volume capacity between about 0.5 liter and about 5 liters, between about 0.5 liter and about 4 liters, between about 0.5 liter and about 3 liters, between about 0.5 liter and about 2.5 liters, between about 0.5 liter and about 2 liters, between about 0.5 liter and about 1.5 liters, between about 0.5 liter and about 1 liter, between about 1 liter and about 5 liters, between about 1 liter and about 4 liters, between about 1 liter and about 3 liters, between about 1 liter and about 2.5 liters, between about 1 liter and about 2 liters, between about 1 liter and about 1.5 liters, inclusive of any volume capacity values therebetween.

In various embodiments, the mesh filter 120 can include a stainless-steel filter. In various embodiments, the mesh filter 120 can have mesh pores between about 0.01 mm to 1 mm.

In various embodiments, the pump can include a DC pump with 6V that can be configured to operate at 100 kPa of pressure (e.g., suctioning power).

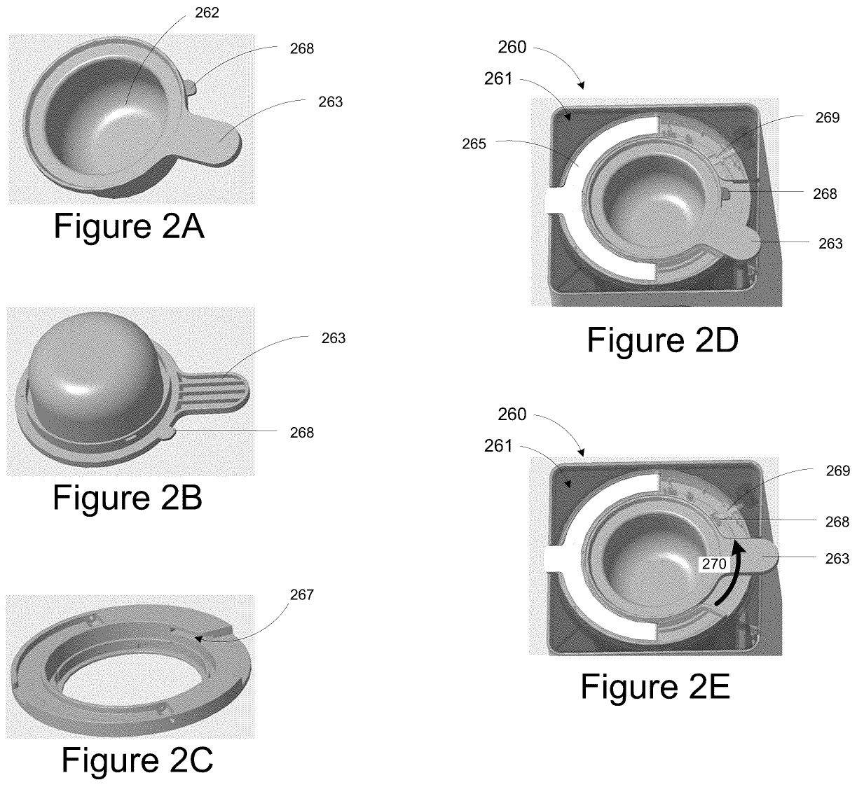

FIGS. 2A-2E illustrate various views of a removable lid assembly 260, in accordance with various embodiments. As illustrated in FIGS. 2A-2E, the removable lid assembly 260 is disposed at or near a top portion of a container of a brewing machine, such as the container 110 of the brewing machine 100, in accordance with various embodiments. As illustrated in FIGS. 2A-2E, the removable lid assembly 260 includes a plurality of lid components 261 that are configured and arranged to interlock to provide a liquid seal to the container. In various embodiments, the plurality of lid components 261 includes a measuring cup 262 having a handle 263, wherein the handle 263 is configured and arranged to be maneuverable to seal the removable lid assembly 260 against at least a portion of the container. In various embodiments, the handle 263 is configured to be pushed or rotated, clockwise or counterclockwise, left or right, along the direction 270 as illustrated in FIG. 2E, to either lock or unlock when the measuring cup 262 is placed within the removable lid assembly 260 on the brewing machine, such as the brewing machine 100.

In various embodiments, the plurality of lid components 261 includes a triggering mechanism 268/269 to turn on an operation (or off, depending on the desired operation) of the brewing machine, such as the brewing machine 100. In various embodiments, the triggering mechanism can include a microswitch mechanism. In various embodiments, the microswitch mechanism may include a protruding or a protruding rod. In various embodiments, a portion of the triggering mechanism, such as the trigger portion 268, can be in the form of the protruding rod, and can be included on the measuring cup 262, as illustrated in FIGS. 2A-2E. Upon rotating the measuring cup 262 along the direction 270 as illustrated in FIG. 2E, the trigger portion/protruding rod 268 may be rotated in such a way that the trigger portion/protruding rod 268 is moved through a wedge opening 267 until the trigger portion/protruding rod 268 comes into contact with the sensor switch 269, which is hidden inside the wedge opening 267 (to avoid inadvertent activation, in accordance with some embodiments). In other words, the triggering mechanism 268/269 is a mechanical sensor-based switch that includes the trigger portion/protruding rod 268 to mechanically come in contact with the sensor switch 269 to activate a switching action, in accordance with various embodiments.

In one or more embodiments, the triggering mechanism 268/269 is an electronic locking mechanism, which may include a trigger portion 268 on the measuring cup 262 and a sensing portion 269 disposed on another portion of the removable lid assembly 260 or the container.

In various embodiments, the removable lid assembly 260 or the plurality of lid components 261 can include a release valve (not shown) which can be used to release pressure from suction during milk extraction within the container, such as the container 110 when a brewing operation is completed. In various embodiments, the release valve can be triggered by an application of the triggering mechanism 268/269 or a separate switch that enables operation of the release valve.

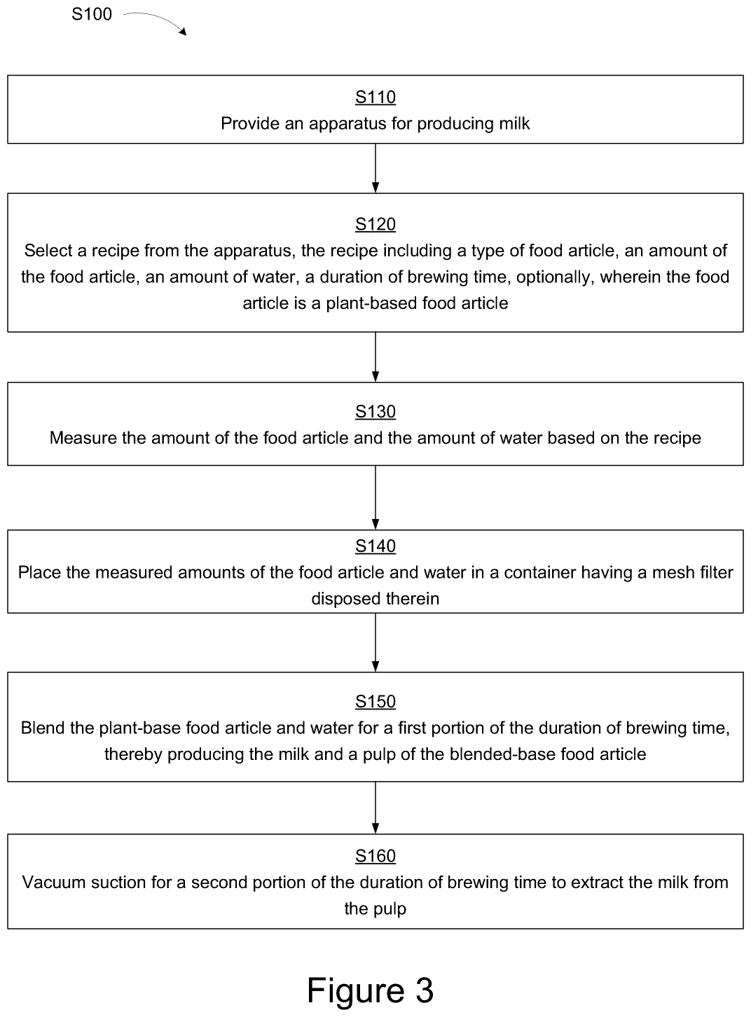

FIG. 3 illustrates a method S100 of producing milk, in accordance with various embodiments. As illustrated in FIG. 3, the method S100 includes at step S110, providing an apparatus (e.g., brewing machine 100) for producing milk, at step S120, selecting a recipe from the apparatus, the recipe including a type of food article, an amount of the food article, an amount of water, a duration of brewing time, optionally, wherein the food article is a plant-based food article; at step S130, measuring the amount of the food article and the amount of water based on the recipe; at step S140, placing the measured amounts of the food article and water in a container having a mesh filter disposed therein; at step S150, blending the plant-base food article and water for a first portion of the duration of brewing time, thereby producing the milk and a pulp of the blended-base food article; and at step S160, vacuum suctioning for a second portion of the duration of brewing time to extract the milk from the pulp.

In various embodiments of the method S100, the selecting of the recipe is performed on a graphic user interface (GUI), e.g., user interface 104, of the apparatus.

In various embodiments, the method S100 may include sealing the container using a removable lid assembly having a plurality of lid components that are configured and arranged to interlock to provide a liquid seal to at least a portion of the container.

In various embodiments of the method S100, the plurality of lid components include a measuring cup having a handle, wherein the handle is configured and arranged to be maneuverable to seal the removable lid assembly against at least the portion of the container.

In various embodiments of the method S100, sealing the container using the removable lid assembly further includes providing a gasket using a gasket to form the liquid seal between the mesh filter and at least the portion of the container. In various embodiments of the method S100, the gasket forms the liquid seal between the mesh filter, at least the portion of the container, and the removable lid assembly. In various embodiments of the method S100, the mesh filter comprises mesh openings in a range between 0.01 mm and 1 mm.

In various embodiments, the method S100 may include draining the milk from the pulp prior to perform vacuum suctioning. In various embodiments of the method S100, draining the milk from the pulp is performed for a third portion of the duration of brewing time.

In various embodiments of the method S100, the pulp of the blended plant-base food article is filtered inside the mesh filter during draining and vacuum suctioning. In various embodiments of the method S100, the extracted milk is collected via a sprout that is fluidically coupled to a vacuum assembly of the apparatus used for vacuum suctioning. In various embodiments, the method S100 can be performed at room or near room temperature. In various embodiments, the method S100 can be performed within a temperature range between 33° F. and 90° F.

In various embodiments, the method S100 of producing milk may use a brewing machine, such as the brewing machine 100. In one or more embodiments, the brewing machine may include one or more components, including, but not limited to:
1. AC 120V 60 Hz 400 W Motor
2. Digital display Touch screen
3. Blending container with 1.5 L capacity
4. Cylindric Stainless-steel Filter with 0.1 mm laser cut mesh
5. Removable Blade with shaft
6. Silicone tube
7. Lid with an open center
8. Measuring cup with 1 cup volume capacity and a sealing mechanism
9. Vacuum Mini Air Pump DC 6V with 100 KPa pressure
10. PCB—Hardware
11. Stainless-steel shaft
12. Draining Spout
13. Proprietary Software
   Relationship Between Components, in Accordance with One or More Embodiments:

Proprietary Software (13) is installed on the PCB—Hardware (10). The digital display Touch screen (2), The AC 120V 60 Hz 400 W Motor (1), and the Vacuum Mini Air Pump DC 6V with 100 KPa pressure and negative force −60 KPa (9) are connected to PCB—Hardware (10). Digital display Touch screen (2) is placed in front of the machine. AC 120V 60 Hz 400 W Motor (1) is placed in the center of the bottom of the machine. Blending container with 1.5 L capacity (3) is fixed on top of the AC 120V 60 Hz 400 W Motor (1) and is connected by the Stainless-steel shaft (11). The silicone tube is connected to the bottom of the Blending container with 1.5 L capacity (3) on one side and the Vacuum Mini Air Pump DC 6V with 100 KPa pressure and negative force −60 KPa (9) on the other side. Another Silicon Tube (6) is connecting the other side of the Vacuum Mini Air Pump DC 6V with 100 KPa pressure and negative force −60 KPa (9) with the Draining Sprout (12), which is fixed in front of the machine. The Lid with an open center (7) is placed on top of the Blending container with 1.5 L capacity (1). Cylindric Stainless-steel Filter with 0.1 mm laser cut mesh (4) is placed in the open center of the Lid with an open center (7). Removable Blade with shaft (5) is connected to the Stainless-steel shaft (11). The Measuring cup with 1 cup volume capacity and a sealing mechanism (8) is placed at the open center of the Lid with an open center (7) and lock it.

How the Brewing Machine Works, in Accordance with One or More Embodiments:

The consumer will set up the machine, following the instructions below.

User Step 1—Place the Lid with an open center (7) on top of the Blending container with 1.5 L capacity (3).

User Step 2—Cylindric Stainless-steel Filter with 0.1 mm laser cut mesh (4) in the open center of the Lid with an open center (7).

User Step 3—Blade with shaft (5) is connected to the Stainless-steel shaft (11) at the bottom of the Blending container with 1.5 L capacity (3).

User Step 4—Follow the instruction on the Digital Display Touch screen (2) to choose the Plant-Base and follow the sequence of steps.

User Step 5—Use the Measuring cup with a sealing mechanism to measure the indicated quantities of the plant base and the water, as suggested by our Proprietary Software (13) on the Digital display Touch screen (2).

User Step 6—Place the Measuring cup with 1 cup volume capacity and a sealing mechanism (8) in the open center of the Lid with open center (7) and lock it.

User Step 7—Press the “Brew” button on the Digital Display Touch screen (2).

After the setup, the machine will follow the procedures below.

Machine Step 1—Proprietary Software (13) will command the PCB—Hardware

(10) to prepare the selected plant-based milk by the consumer.

Machine Step 2—PCB—Hardware (10) sends a command to the AC 120V 60 Hz 400 W Motor (1) to blend the ingredients according to the recipe pre-programmed on the Proprietary Software (13).

Machine Step 3—AC 120V 60 Hz 400 W Motor (1) blends the ingredients according to the recipe pre-programmed on the Proprietary Software.

Machine Step 4—PCB—Hardware (10) sends a command to the Vacuum Mini Air Pump DC 6V with 100 KPa pressure and negative force −60 KPa (9) to drain the milk according to the recipe pre-programmed on the Proprietary Software.

How the Brewing Machine Produces the Cold Brew Milk, in Accordance with One or More Embodiments:

In an example embodiment, the user press “Start” on the Digital display Touch screen (2) to initiate the brewing step-by-step process. The first step is to select one of the plant-base options such as but not limited to Almond, Walnut, Cashew, Brazil Nut, Oat, Pistachio, Coconut, Hemp Seed, Pine Nut, Hazelnut, Macadamia, and Pecan, on the menu displayed on the Digital display Touch screen (2). The second step is to follow the recipe instructions provided by the Proprietary Software (13) that identifies the selected plant base, and suggests the ideal quantity of the plant base, that can vary from but is not limited to ½ Cups to 2 Cups of the plant-base, and the water that can vary from but is not limited 3 to 4 cups. To do that, the user will utilize the Measuring cup with 1 cup volume capacity and a sealing mechanism (8) to measure the ingredients according to the instructions on the Digital display Touch screen (2) and fill the Blending container can have but is not limited to a capacity between 0.5 Liters to 10 Liters (3) with the plant-base of their choice and the water according to the suggested proportions recommended by the Proprietary Software (13). To brew the better taste milk, all the plant bases utilized should be in their raw form, and the water temperature can be between 33° F. and 72° F., between 40° F. and 80° F., between 50° F. and 90° F., or any temperature higher then freezing and lower then boiling.

After completing the step two, the user attaches the Measuring cup with 1 cup volume capacity and a sealing mechanism (8) to the Lid with an open center (7), completely sealing the Blending container (3). Finally, the user presses the “Brew” button on the screen, and the machine starts the brewing process. There is a customized brewing processes for each plant base, that controls the blending and the draining time, according to the recipe pre-programed on the on the Proprietary software (13). First, the machine will initiate the blending process by starting the AC 120V 60 Hz Motor with the power capacity that can be but is not limited to between about 100 W to 2000 W (1) and keep it on for a time that can vary but is not limited to about 10 seconds, about 20 seconds, about 30 seconds, about 40 seconds, about 50 seconds, about 60 seconds, to about 120 seconds. In some embodiments, the blending process can take between 10 seconds and 180 seconds, between 10 seconds and 150 seconds, between 20 seconds and 180 seconds, etc. The AC 120V 60 Hz Motor (1) will drive the Removable Blade with shaft (5) for the determined time to break down the plant base to small particles that can vary but are not limited between about 0.11 mm and 1 mm, between about 0.2 mm and 1.1 mm, between about 0.3 mm and 1.5 mm. In some embodiments the particles can be bigger than 1.5 mm. This blending method combines the small particles of the plant base with the water, converting two separate ingredients into a liquid with a pulp. After blending, the machine begins the milk production. The milk production materializes when the Vacuum Mini Air Pump DC 6V that can have a pressure from but not limited to about 10 KPa to 1000 Kpa and negative force that can have but is not limited to about −10 KPa to −1000 Kpa (9) starts draining the liquid from inside the Cylindric Stainless-steel Filter a laser cut mesh that can have but is not limited to about 0.01 mm to 1 mm (4) that is placed inside the Blending container (3). The small mesh on the filter holds all the pulp that is larger than but is not limited to 0.01 mm inside itself, and the milk starts coming out through the Draining Spout (12). This process continues until the liquid part of the combined ingredients completely drains from the Blending container (3).

When the liquid is completely drained, the Vacuum Mini Air Pump DC 6V (9) starts creating a vacuum inside the Blending container (3). The vacuum development pushes the air from inside Cylindric Stainless-steel Filter (4) against the plant base pulp left inside filter and squeezes the remaining milk from the pulp until all the milk drains. Once all the liquid is extruded from the pulp, there will remain small particles of the selected plant base, measuring from but not limited to between about 0.11 mm and 1 mm, between about 0.2 mm and 1.1 mm, between about 0.3 mm and 1.5 mm. In some embodiments the particles can be bigger than 1.5 mm.

How to Operate the Brewing Machine, in Accordance with One or More Embodiments:

User Step 1—Place the Lid with an open center (7) on top of the Blending container with 1.5 L capacity (3).

User Step 2—Cylindric Stainless-steel Filter with 0.1 mm laser cut mesh (4) in the open center of the Lid with an open center (7).

User Step 3—Removable Blade with shaft (5) is connected to the Stainless-steel shaft (11) at the bottom of the Blending container with 1.5 L capacity (3).

User Step 4—Follow the instruction on the Digital Display Touch screen (2) to choose the Plant-Base and follow the sequence of steps.

User Step 5—Use the Measuring cup with a sealing mechanism to measure the indicated quantities of the plant base and the water, as suggested by our Proprietary Software (13) on the Digital display Touch screen (2).

User Step 6—Place the Measuring cup with 1 cup volume capacity and a sealing mechanism (8) in the open center of the Lid with open center (7) and lock it.

User Step 7—Press the “Brew” button on the Digital Display Touch screen (2).

### Recitation of Embodiments

Embodiment 1. An apparatus comprising: a container; a mesh filter disposed inside the container and configured and arranged to receive a food article; a blade assembly disposed inside the mesh filter and configured and arranged to fragment the food article to produce a liquid; and a vacuum assembly fluidically coupled to the container and configured and arranged to remove the liquid from the container, wherein, during operation, the mesh filter is configured and arranged to capture the fragmented food article, and the vacuum assembly is configured and arranged to suction the liquid produced from the fragmentation of the food article.

Embodiment 2. The apparatus of Embodiment 1, wherein the container further comprises a removable lid assembly having a plurality of lid components that are configured and arranged to interlock to provide a liquid seal to the container.

Embodiment 3. The apparatus of Embodiment 2, wherein the plurality of lid components includes a measuring cup having a handle, the handle configured and arranged to be maneuverable to seal the removable lid assembly against at least a portion of the container and, optionally, comprises a triggering mechanism to turn on an operation of the apparatus.

Embodiment 4. The apparatus of Embodiments 2 or 3, wherein the triggering mechanism comprises a sensor-based switch, which may include a mechanical sensor-based switch, a electrical sensor-based switch, or a magnetic sensor-based switch, as disclosed herein.

Embodiment 5. The apparatus of any one of Embodiments 2-4, wherein the plurality of lid components includes a gasket interdisposed between at least two adjacent lid components, the gasket configured to interlock with the two adjacent lid components to provide a liquid seal to at least a portion of the container.

Embodiment 6. The apparatus of Embodiment 5, wherein the gasket is configured to provide a liquid seal between the mesh filter and at least the portion of the container.

Embodiment 7. The apparatus of Embodiment 6, wherein the gasket is configured to provide a liquid seal between the mesh filter, at least the portion of the container, and the removable lid assembly.

Embodiment 8. The apparatus of any one of Embodiments 1-7, wherein the mesh filter comprises mesh openings in a range between 0.01 mm and 1 mm.

Embodiment 9. The apparatus of any one of Embodiments 1-8, wherein the blade assembly is an integrated blade assembly comprising a plurality of single blades stackable in layers to form an integrated blade having multiple blade components.

Embodiment 10. The apparatus of Embodiment 9, wherein each of the plurality of single blades comprises a mounting hole through which each single blade is mounted on a blade shaft to form the integrated blade assembly.

Embodiment 11. The apparatus of any one of Embodiments 1-10, further comprising: a sprout fluidically coupled to the vacuum assembly for removing the liquid from the container.

Embodiment 12. The apparatus of any one of Embodiments 1-11, wherein the mesh filter and/or the blade assembly are removable.

Embodiment 13. The apparatus of any one of Embodiments 1-12, further comprising: a graphic user interface (GUI) configured to receive a user input for selecting a recipe, wherein the recipe includes at least one of a selection of the food article, an amount of the food article, and a length of time for fragmenting the food article using the blade assembly.

Embodiment 14. The apparatus of Embodiment 13, wherein the GUI is configured to display a plurality of recipes that are preprogrammed on the GUI and/or one or more recipes that are downloadable from an external source, the external source selected from the group consisting of a network, a computing device, a cloud server, and/or combinations thereof.

Embodiment 15. A method of producing milk, comprising: providing an apparatus for producing milk; selecting a recipe from the apparatus, the recipe including a type of food article, an amount of the food article, an amount of water, a duration of brewing time, optionally, wherein the food article is a plant-based food article; measuring the amount of the food article and the amount of water based on the recipe; placing the measured amounts of the food article and water in a container having a mesh filter disposed therein; blending the plant-base food article and water for a first portion of the duration of brewing time, thereby producing the milk and a pulp of the blended-base food article; and vacuum suctioning for a second portion of the duration of brewing time to extract the milk from the pulp.

Embodiment 16. The method of Embodiment 15, wherein the selecting of the recipe is performed on a graphic user interface (GUI) of the apparatus.

Embodiment 17. The method of Embodiments 15 or 16, further comprising: sealing the container using a removable lid assembly having a plurality of lid components that are configured and arranged to interlock to provide a liquid seal to at least a portion of the container.

Embodiment 18. The method of Embodiment 17, wherein the plurality of lid components includes a measuring cup having a handle, wherein the handle is configured and arranged to be maneuverable to seal the removable lid assembly against at least the portion of the container.

Embodiment 19. The method of Embodiment 18, wherein sealing the container using the removable lid assembly further includes providing a gasket using a gasket to form the liquid seal between the mesh filter and at least the portion of the container.

Embodiment 20. The method of Embodiment 19, wherein the gasket forms the liquid seal between the mesh filter, at least the portion of the container, and the removable lid assembly.

Embodiment 21. The method of any one of Embodiments 15-20, wherein the mesh filter comprises mesh openings in a range between 0.01 mm and 1 mm.

Embodiment 22. The method of any one of Embodiments 15-21, further comprising: draining the milk from the pulp prior to perform vacuum suctioning.

Embodiment 23. The method of Embodiment 22, wherein draining the milk from the pulp is performed for a third portion of the duration of brewing time.

Embodiment 24. The method of Embodiment 23, wherein the pulp of the blended plant-base food article is filtered inside the mesh filter during draining and vacuum suctioning.

Embodiment 25. The method of any one of Embodiments 15-24, wherein the extracted milk is collected via a sprout that is fluidically coupled to a vacuum assembly of the apparatus used for vacuum suctioning.

Embodiment 26. The method of any one of Embodiments 15-25, wherein the apparatus is the apparatus of any one of Embodiments 1-14.

Embodiment 27. The method of any one of Embodiments 15-26, wherein the method is performed at room or near room temperature.

Embodiment 28. The method of any one of Embodiments 15-26, wherein the method is performed within a temperature range between 33° F. and 90° F.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An apparatus comprising:
a container;
a mesh filter disposed inside the container and configured and arranged to receive a food article;
a blade assembly disposed inside the mesh filter and configured and arranged to fragment the food article to produce a liquid; and
a vacuum assembly fluidically coupled to the container and configured and arranged to remove the liquid from the container,
wherein, during operation, the mesh filter is configured and arranged to capture the fragmented food article, and the vacuum assembly is configured and arranged to suction the liquid produced from the fragmentation of the food article.

2. The apparatus of claim 1, wherein the container further comprises a removable lid assembly having a plurality of lid components that are configured and arranged to interlock to provide a liquid seal to the container.

3. The apparatus of claim 2, wherein the plurality of lid components includes a measuring cup having a handle, the handle configured and arranged to be maneuverable to seal the removable lid assembly against at least a portion of the container and, optionally, comprises a triggering mechanism to turn on an operation of the apparatus.

4. The apparatus of claim 2, wherein the triggering mechanism comprises a sensor-based switch.

5. The apparatus of claim 2, wherein the plurality of lid components includes a gasket interdisposed between at least two adjacent lid components, the gasket configured to interlock with the two adjacent lid components to provide a liquid seal to at least a portion of the container.

6. The apparatus of claim 5, wherein the gasket is configured to provide a liquid seal between the mesh filter and at least the portion of the container.

7. The apparatus of claim 6, wherein the gasket is configured to provide a liquid seal between the mesh filter, at least the portion of the container, and the removable lid assembly.

8. The apparatus of claim 1, wherein the mesh filter comprises mesh openings in a range between 0.01 mm and 1 mm.

9. The apparatus of claim 1, wherein the blade assembly is an integrated blade assembly comprising a plurality of single blades stackable in layers to form an integrated blade having multiple blade components.

10. The apparatus of claim 9, wherein each of the plurality of single blades comprises a mounting hole through which each single blade is mounted on a blade shaft to form the integrated blade assembly.

11. The apparatus of claim 1, further comprising:
a sprout fluidically coupled to the vacuum assembly for removing the liquid from the container.

12. The apparatus of claim 1, wherein the mesh filter and/or the blade assembly are removable.

13. The apparatus of claim 1, further comprising:
a graphic user interface (GUI) configured to receive a user input for selecting a recipe, wherein the recipe includes at least one of a selection of the food article, an amount of the food article, and a length of time for fragmenting the food article using the blade assembly.

14. The apparatus of claim 13, wherein the GUI is configured to display a plurality of recipes that are preprogrammed on the GUI and/or one or more recipes that are downloadable from an external source, the external source selected from the group consisting of a network, a computing device, a cloud server, and/or combinations thereof.

15. A method of producing milk, comprising:
providing an apparatus for producing milk;
selecting a recipe from the apparatus, the recipe including a type of food article, an amount of the food article, an amount of water, a duration of brewing time, optionally, wherein the food article is a plant-based food article;
measuring the amount of the food article and the amount of water based on the recipe;
placing the measured amounts of the food article and water in a container having a mesh filter disposed therein;
blending the plant-base food article and water for a first portion of the duration of brewing time, thereby producing the milk and a pulp of the blended-base food article; and
vacuum suctioning for a second portion of the duration of brewing time to extract the milk from the pulp.

16. The method of claim 15, wherein the selecting of the recipe is performed on a graphic user interface (GUI) of the apparatus.

17. The method of claim 15, further comprising:
sealing the container using a removable lid assembly having a plurality of lid components that are configured and arranged to interlock to provide a liquid seal to at least a portion of the container.

18. The method of claim 17, wherein the plurality of lid components includes a measuring cup having a handle, wherein the handle is configured and arranged to be maneuverable to seal the removable lid assembly against at least the portion of the container.

19. The method of claim 18, wherein sealing the container using the removable lid assembly further includes providing a gasket using a gasket to form the liquid seal between the mesh filter and at least the portion of the container.

20. The method of claim 19, wherein the gasket forms the liquid seal between the mesh filter, at least the portion of the container, and the removable lid assembly.
